(19) United States
(12) Patent Application Publication
(10) Pub. No.: US 2026/0298613 A1
(43) Pub. Date: Oct. 1, 2026

(54) INTERFERENCE OBSERVATION DEVICE AND INTERFERENCE OBSERVATION METHOD

(71) Applicant: HAMAMATSU PHOTONICS K.K., Hamamatsu-shi, Shizuoka (JP)

(72) Inventors: Toyohiko YAMAUCHI, Shizuoka (JP); Natsuki SUZUKI, Shizuoka (JP)

(73) Assignee: HAMAMATSU PHOTONICS K.K., Hamamatsu-shi, Shizuoka (JP)

(21) Appl. No.: 19/475,557

(22) PCT Filed: Apr. 10, 2024
(86) PCT No.: PCT/JP2024/014582

§ 371 Date: Oct. 15, 2025

(30) Foreign Application Priority Data
Apr. 24, 2023 (JP) 2023-070971

(51) Int. Cl. G01B 9/02015; G01B 9/02

(52) U.S. Cl. CPC G01B 9/02015; G01B 9/02041

(57) ABSTRACT

An interference observation device includes a light source; an interference optical system that includes a reference mirror, splits light output from the light source into a first light and a second light, and outputs interference light between the first light reflected by an observation object and the second light reflected by the reference mirror; an image sensor that detects the interference light; and a processing unit that acquires an interference image. The interference optical system includes a mechanism configured to change a focal condition of an optical path of the second light. The processing unit separates observation surface information and non-observation surface information based on a plurality of the interference images obtained when the focal condition of the optical path of the second light is changed in a state in which a focal point of the first light is aligned with an observation surface of the observation object.

### TECHNICAL FIELD

One aspect of the present invention relates to an interference observation device and an interference observation method.

### BACKGROUND ART

For example, Patent Literature 1 describes an interference observation device including a light source; an interference optical system that branches light output from the light source into a first branched light and a second branched light, reflects the first branched light off an observation object, combines the first branched light and the second branched light (reference light), and outputs the combined light; a light receiving unit that receives the combined light and outputs a detection signal; and an image acquisition unit that acquires an interference image based on the detection signal.

### CITATION LIST

### Patent Literature

Patent Literature 1: PCT International Publication No. WO2016-121250

### SUMMARY OF INVENTION

### Technical Problem

In the interference observation device described above, when one interface of the observation object is observed as an observation surface, for example, if grinding marks or the like exist on another interface, there is a possibility that the grinding marks or the like affect an interference image to be acquired. In this case, information related to the observation surface cannot be acquired with high accuracy, which is a risk.

An object of one aspect of the present invention is to provide an interference observation device and an interference observation method capable of acquiring information related to an observation surface with high accuracy.

### Solution to Problem

An interference observation device according to one aspect of the present invention is [1] “an interference observation device including: a light source that outputs light; an interference optical system that includes a reference mirror, splits the light output from the light source into a first light and a second light, and outputs interference light between the first light reflected by an observation object and the second light reflected by the reference mirror; an image sensor that detects the interference light; and a processing unit that acquires an interference image based on a detection result of the image sensor. The interference optical system includes a mechanism configured to change a focal condition of an optical path of the second light. The processing unit separates observation surface information related to an observation surface of the observation object and non-observation surface information related to a non-observation surface other than the observation surface, based on a plurality of the interference images obtained when the focal condition of the optical path of the second light is changed in a state in which a focal point of the first light is aligned with the observation surface”.

As a result of diligent study, the inventors have found that when the focal condition of the optical path of the second light is changed in a state in which the focal point of the first light is aligned with the observation surface of the observation object, in the plurality of acquired interference images, the amount of modulation received by components related to the non-observation surface other than the observation surface is significantly greater than the amount of modulation received by components related to the observation surface. Therefore, in the interference observation device according to one aspect of the present invention, information related to the observation surface (hereinafter, also referred to as “observation surface information”) and information related to the non-observation surface (hereinafter, also referred to as “non-observation surface information”) are separated based on the plurality of interference images acquired in such a manner. Accordingly, the observation surface information can be selectively obtained by excluding the non-observation surface information from the interference image, and the observation surface information can be acquired with high accuracy.

An interference observation device according to one aspect of the present invention may be [2] “the interference observation device according to [1], in which the processing unit separates the observation surface information and the non-observation surface information based on a first interference image obtained when the reference mirror is located at a first position and a second interference image obtained when the reference mirror is moved from the first position along the optical path of the second light by a distance equal to or greater than half a wavelength of the light output from the light source”. In this case, the observation surface information and the non-observation surface information of the interference image can be separated by moving the reference mirror along the optical path of the second light.

An interference observation device according to one aspect of the present invention may be [3] “the interference observation device according to [1], in which the interference optical system includes a reference objective lens that guides the second light to the reference mirror and that is movable, and the processing unit separates the observation surface information and the non-observation surface information based on a first interference image obtained when the reference objective lens is located at a first position and a second interference image obtained when the reference objective lens is moved from the first position along the optical path of the second light by a distance equal to or greater than half a wavelength of the light output from the light source”. In this case, the observation surface information and the non-observation surface information of the interference image can be separated by moving the reference objective lens along the optical path of the second light.

An interference observation device according to one aspect of the present invention may be [4] “the interference observation device according to [1], in which the light source includes a first light source that outputs light of a first wavelength, and a second light source that outputs light of a second wavelength different from the first wavelength, the interference optical system includes a dispersive medium disposed on the optical path of the second light, and the processing unit separates the observation surface information and the non-observation surface information based on a first interference image obtained when the light is output from the first light source and a second interference image obtained when the light is output from the second light source”. In this case, the observation surface information and the non-observation surface information can be separated using light of two types of wavelengths.

An interference observation device according to one aspect of the present invention may be [5] “the interference observation device according to any one of [1] to [4], in which the observation object includes a device portion and a cap portion provided on a front surface of the device portion via an air layer, the interference optical system causes the first light to be incident on the observation object from a cap portion side, the observation surface is the front surface of the device portion, and the non-observation surface includes a front surface and a back surface of the cap portion”. In this case, observation surface information related to the front surface of the device portion can be acquired with high accuracy while suppressing the influence of the front surface and the back surface of the cap portion.

An interference observation device according to one aspect of the present invention may be [6] “the interference observation device according to any one of [1] to [4], in which the observation object includes a device portion and a film portion provided on a front surface of the device portion, the interference optical system causes the first light to be incident on the observation object from a film portion side, the observation surface is the front surface or a back surface of the device portion, and the non-observation surface includes a front surface and a back surface of the film portion”. In this case, observation surface information related to the front surface or the back surface of the device portion can be acquired with high accuracy while suppressing the influence of the front surface and the back surface of the film portion.

An interference observation device according to one aspect of the present invention may be [7] “the interference observation device according to any one of [1] to [4], in which the observation object includes a first device portion and a second device portion provided on a front surface of the first device portion, the interference optical system causes the first light to be incident on the observation object from a second device portion side, the observation surface is the front surface or a back surface of the first device portion, and the non-observation surface includes a front surface and a back surface of the second device portion”. In this case, observation surface information related to the front surface or the back surface of the first device portion can be acquired with high accuracy while suppressing the influence of the front surface and the back surface of the second device portion.

An interference observation device according to one aspect of the present invention may be [8] “the interference observation device according to any one of [1] to [4], in which the observation object includes a device portion, the interference optical system causes the first light to be incident on the observation object from a front surface side of the device portion, the observation surface is a back surface of the device portion, and the non-observation surface is a front surface of the device portion”. In this case, observation surface information related to the back surface of the device portion can be acquired with high accuracy while suppressing the influence of the front surface of the device portion.

An interference observation device according to one aspect of the present invention may be [9] “the interference observation device according to any one of [1] to [4], in which the observation surface is an interface of the observation object, and the non-observation surface is a front surface of an optical element between a detection surface of the image sensor and the observation object”. In this case, observation surface information related to the interface of the observation object can be acquired with high accuracy while suppressing the influence of the front surface of the optical element between the image sensor and the observation object.

An interference observation device according to one aspect of the present invention may be [10] “the interference observation device according to [9], in which the observation surface is the interface of the observation object, and the non-observation surface is a front surface of a protective plate of the image sensor, the protective plate being mounted spaced apart from the detection surface of the image sensor”. In this case, observation surface information related to the interface of the observation object can be acquired with high accuracy while suppressing the influence of the front surface of the protective plate of the image sensor.

An interference observation device according to one aspect of the present invention may be [11] “the interference observation device according to any one of [1] to [10] further including: a display unit that displays at least one of a table showing positions of a plurality of foreign objects in the interference image and a defocus degree of each of the plurality of foreign objects and an image showing a distribution of the defocus degrees in the interference image”. In this case, foreign objects on the observation surface and foreign objects on the non-observation surface can be easily distinguished and identified by at least one of the table and the image displayed on the display unit.

An interference observation device according to one aspect of the present invention may be [12] “the interference observation device according to any one of [1] to [11] further including: a storage unit that stores at least one of a table showing positions of a plurality of foreign objects in the interference image and a defocus degree of each of the plurality of foreign objects and an image showing a distribution of the defocus degrees in the interference image”. In this case, foreign objects on the observation surface and foreign objects on the non-observation surface can be easily distinguished and identified by using at least one of the table and the image stored in the storage unit.

An interference observation method according to one aspect of the present invention is [13] “an interference observation method including: a light output step of outputting light from a light source; an interference light output step of splitting the light output from the light source into a first light and a second light, and outputting interference light between the first light reflected by an observation object and the second light reflected by a reference mirror; an interference light detection step of detecting the interference light using an image sensor; and a processing step of acquiring an interference image based on a detection result of the image sensor. In the processing step, observation surface information related to an observation surface of the observation object and non-observation surface information related to a non-observation surface other than the observation surface are separated based on a plurality of the interference images obtained when a focal condition of an optical path of the second light is changed in a state in which a focal point of the first light is aligned with the observation surface”.

In the interference observation method as well, the observation surface information can be selectively obtained by excluding the non-observation surface information from the interference image, and the observation surface information can be acquired with high accuracy.

### Advantageous Effects of Invention

According to one aspect of the present invention, it is possible to provide the interference observation device and the interference observation method capable of acquiring information related to the observation surface with high accuracy.

### BRIEF DESCRIPTION OF DRAWINGS

FIG. 1 is a configuration view showing an interference observation device according to a first embodiment.

FIG. 2 is a flowchart showing an example of the operation of the interference observation device in FIG. 1.

FIG. 3(a) is a photograph showing an example of a first phase image. FIG. 3(b) is a photograph showing an example of a second phase image.

FIG. 4(a) is a timing chart showing an example of the operation of a reference mirror. FIG. 4(b) is a timing chart showing another example of the operation of the reference mirror.

FIG. 5(a) is a photograph showing an example of a bright spot-extracted phase image. FIG. 5(b) is a photograph showing an example of a bright spot position image.

FIG. 6(a) is a photograph showing an example of a differential phase image. FIG. 6(b) is a photograph showing an example of a defocus index image.

FIG. 7(a) is a photograph showing an example of an in-focus phase image. FIG. 7(b) is a photograph showing an example of an out-of-focus phase image.

FIG. 8 is a view showing a defocus index table.

FIG. 9 is a configuration view showing an interference observation device according to a second embodiment.

FIG. 10 is a graph showing the spectral characteristic of light output by a first light source and a second light source.

FIG. 11 is a configuration view showing an interference observation device according to a third embodiment.

FIG. 12 is a flowchart showing an example of the operation of the interference observation device in FIG. 11.

FIG. 13(a) is a photograph showing an example of a first phase image. FIG. 13(b) is a photograph showing an example of a second phase image.

FIG. 14(a) is a photograph showing an example of a differential phase image. FIG. 14(b) is a view obtained by binarizing the photograph in FIG. 13(a).

FIG. 15 is a view for describing the field of view of an imaging device of the interference observation device in FIG. 11.

FIG. 16(a) is a cross-sectional view for describing an observation object according to a modification example. FIG. 16(b) is a cross-sectional view for describing an observation object according to a modification example.

FIG. 17 is a cross-sectional view for describing an observation object according to a modification example.

### DESCRIPTION OF EMBODIMENTS

Hereinafter, embodiments will be described in detail with reference to the drawings. In the following description, the same reference signs are used for the same or corresponding elements, and duplicate descriptions will be omitted.

### First Embodiment

### [Configuration of Interference Observation Device]

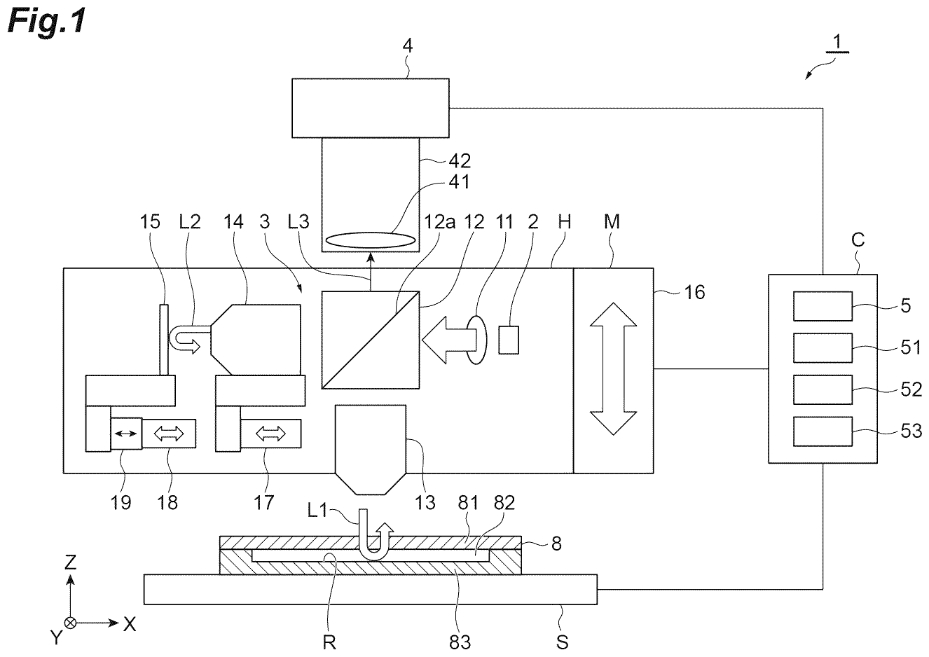

As shown in FIG. 1, an interference observation device 1 according to a first embodiment includes a light source 2, an interference optical system 3, an image sensor 4, a processing unit 5, and a stage S. The interference observation device 1 is an interference microscope for observing an observation object 8 disposed on the stage S using interference of light. The observation object 8 is, for example, a semiconductor device, but may be other industrial samples made of metal, glass, resin, liquid crystal, polymer compound, or the like. The observation object 8 may be a biological sample such as a cell or a cell mass. Hereinafter, in the following description, an X direction, a Y direction perpendicular to the X direction, and a Z direction perpendicular to both the X direction and the Y direction are set as shown in FIG. 1.

The interference observation device 1 is configured to be able to perform internal observation for observing the inside of the observation object 8 in addition to surface observation for observing a front surface (outer surface) of the observation object 8. In internal observation, an observation surface R located inside the observation object 8 is observed. In this example, the observation object 8 is a semiconductor device with a cap (so-called capped device), and includes a first layer 81, a second layer 82, and a third layer 83.

The first layer 81 is a layer made of at least one of a semiconductor, glass, and resin, and constitutes a cap portion. The second layer 82 is an air layer, and is also referred to as an air cap. The third layer 83 is a semiconductor layer, and constitutes a device portion in which a pattern of functional elements is formed on a wafer. Here, the third layer 83 is a patterned chip. The first layer 81 to the third layer 83 are disposed (laminated) in order of the third layer 83, the second layer 82, and the first layer 81, and the observation object 8 is disposed on the stage S such that the third layer 83 is in contact with the stage S. The first layer 81 is provided on a front surface of the third layer 83 via the second layer 82. The observation surface R is set at any one of the interfaces between the first layer 81, the second layer 82, and the third layer 83. Here, the observation surface R is set at the interface between the second layer 82 and the third layer 83. The observation surface R is the front surface of the third layer 83. A front surface (a surface on an interference optical system 3 side) and a back surface (a surface on a stage S side) of the first layer 81 may be a mirror-polished surfaces and a ground surface. The observation surface R can be observed through the first layer 81 by using light having a wavelength that transmits through the first layer 81, as the light output from the light source 2.

The light source 2 outputs incoherent light. The light source 2 is, for example, a lamp-based light source such as a halogen lamp, a light emitting diode (LED) light source, a superluminescent diode (SLD) light source, an amplified spontaneous emission (ASE) light source, or the like.

In this example, the interference optical system 3 is configured as a Linnik interference type. The interference optical system 3 includes a lens 11, a beam splitter 12, an objective lens 13, a reference objective lens 14, and a reference mirror 15. The interference optical system 3 is disposed inside a housing H, together with the light source 2, and constitutes an optical module M. The optical module M is movable along the Z direction by a predetermined actuator 16. The Z direction is a direction parallel to an optical axis of the objective lens 13, and is a direction parallel to a direction in which a first light L1 to be described later is incident on the observation object 8.

The lens 11 collimates light output from the light source 2. The beam splitter 12 is, for example, a prism having an optical surface 12a, and splits the light collimated by the lens 11 into the first light L1 and a second light L2 at the optical surface 12a. The beam splitter 12 outputs the first light L1 to the objective lens 13, and outputs the second light L2 to the reference objective lens 14. In addition, the first light L1 reflected by the observation surface R of the observation object 8 is incident on the optical surface 12a via the objective lens 13, and the second light L2 reflected by the reference mirror 15 is incident on the optical surface 12a via the reference objective lens 14. The first light L1 and the second light L2 are combined at the optical surface 12a to become an interference light L3. The interference optical system 3 outputs the interference light L3 to the image sensor 4.

The objective lens 13 focuses the first light L1 output from the beam splitter 12 on the observation object 8 disposed on the stage S. In addition, the first light L1 reflected by the observation surface R of the observation object 8 is incident on the objective lens 13. The objective lens 13 outputs the incident first light L1 to the beam splitter 12.

The reference objective lens 14 guides the second light L2, which is output from the beam splitter 12, to the reference mirror 15, and focuses the second light L2 on the reference mirror 15. In addition, the reference objective lens 14 outputs the second light L2 reflected by the reference mirror 15 to the beam splitter 12. The reference mirror 15 reflects the second light L2 output from the reference objective lens 14 back to the reference objective lens 14.

A stepping motor 17 for moving the reference objective lens 14 and a stepping motor 18 and a piezoelectric element 19 for moving the reference mirror 15 are further disposed inside the housing H of the optical module M. The stepping motor 17 moves the reference objective lens 14 along an optical axis direction (for example, the X direction) of the second light L2 perpendicular to the Z direction. The stepping motor 18 and the piezoelectric element 19 move the reference mirror 15 along the optical axis direction of the second light L2.

A response time of the stepping motors 17 and 18 is greater than 10 msec, and a response time of the piezoelectric element 19 is less than 1 msec. Namely, the response time of the piezoelectric element 19 is shorter than the response time of the stepping motors 17 and 18. A stroke (minimum movement distance) of the stepping motors 17 and 18 is several mm, and a stroke of the piezoelectric element 19 is approximately 10 μm. Namely, the stroke of the piezoelectric element 19 is smaller than the stroke of the stepping motors 17 and 18. A lifetime drive count of the stepping motors 17 and 18 is less than 1 million cycles, and a lifetime drive count of the piezoelectric element 19 is more than 10 billion cycles. Namely, the lifetime drive count of the piezoelectric element 19 is more than the lifetime drive count of the stepping motors 17 and 18.

The image sensor 4 is, for example, an image sensor (camera) such as a CCD area image sensor or a CMOS area image sensor. The image sensor 4 detects (captures an image of) the interference light L3 output from the interference optical system 3 (the beam splitter 12). A lens 41 and a lens barrel 42 are disposed between the image sensor 4 and the interference optical system 3. The lens 41 forms an image of the interference light L3 output from the interference optical system 3 on an imaging surface of the image sensor 4. The lens 41 is accommodated in the lens barrel 42. The lens barrel 42 is formed in, for example, a cylindrical shape, and is fixed to the image sensor 4 to surround the imaging surface.

The processing unit 5 is communicably connected to each part of the interference observation device 1 including the light source 2, the interference optical system 3, the image sensor 4, and the stage S, and acquires an interference image based on the detection result of the interference light L3 in the image sensor 4. The interference image includes, for example, a phase image, an amplitude image, a complex image, various images to be described later, and an image corresponding to any of these images.

The processing unit 5 is configured, for example, by a computer C including a processor (CPU) and a RAM and a ROM that are storage media. The computer C includes a storage region (storage unit) 51 that stores various information; an input unit 52 that accepts input of various information; and a display unit 53 that displays various information. The input unit 52 is, for example, a device that accepts an operation input from a user, such as a mouse or a keyboard. The display unit 53 is, for example, a display that displays an image. The input unit 52 and the display unit 53 may be commonly configured as, for example, a touch panel, and in this case, may be configured as a graphical user interface (GUI). In addition, in this example, the processing unit 5, the storage region 51, the input unit 52, and the display unit 53 are configured as one device; however, at least one thereof may be configured as a separate device, for example, a mobile terminal or the like.

The stage S is a stage for disposing the observation object 8, and is movable along an XY plane perpendicular to the Z direction in which the first light L1 is incident on the observation object 8. Accordingly, in the interference observation device 1, the observation surface R of the observation object 8 can be observed (an interference image can be acquired) while moving the stage S along the XY plane, namely, while changing the observation position of the observation object 8.

In the interference observation device 1, first, incoherent light is output from the light source 2 (light output step). The light is collimated by the lens 11, and is split into the first light L1 and the second light L2 by the beam splitter 12. The first light L1 is focused on the observation object 8 by the objective lens 13, is reflected at the interface of the observation object 8, and is input to the beam splitter 12 via the objective lens 13. The second light L2 is focused on the reference mirror 15 by the reference objective lens 14, is reflected by the reference mirror 15, and is input to the beam splitter 12 via the reference objective lens 14. The beam splitter 12 combines the first light L1 and the second light L2 that are input, and outputs interference light (interference light output step). The output interference light is detected by the image sensor 4 (interference light detection step). The processing unit 5 acquires an interference image based on the detection result of the image sensor 4 (processing step).

In addition, in the interference observation device 1, the image sensor 4 performs imaging to acquire four interference images, and the processing unit 5 constructs (acquires) one interference image based on the acquired four interference images. The piezoelectric element 19 finely moves the reference mirror 15 in accordance with the imaging timing of the four interference images. Accordingly, the optical path length difference between the first light L1 and the second light L2 differs among the four interference images. The amount of movement of the reference mirror 15 for acquiring the four interference images is less than a wavelength λ of the light output from the light source 2. In this example, the optical path length difference (phase shift interval) of the second light L2 among the four interference images is λ/4. When the reference mirror 15 is finely moved such that the change width of the optical path length becomes λ/4, keeping in mind that the second light L2 (hereinafter, also referred to as “reference light”) moves back and forth along an optical path of the second light L2 (hereinafter, also referred to as a “reference optical path”), the actual movement step of the reference mirror 15 becomes λ/8, and for example, in the case of 2=532 nm, the value of the actual movement step is 66.5 nm. The method for acquiring interference images is not limited to the method in the above-described example, and may be any of various known methods.

In the present embodiment, the processing unit 5 separates observation surface information related to the observation surface R and non-observation surface information related to a non-observation surface other than the observation surface R, based on a plurality of interference images obtained when the focal condition of the optical path of the second light L2 is changed in a state in which the focal point of the first light L1 is aligned with the observation surface R of the observation object 8. In other words, in the processing step, the observation surface information and the non-observation surface information are separated based on the plurality of interference images obtained when the focal condition of the optical path of the second light L2 is changed in a state in which the focal point of the first light L1 is aligned with the observation surface R. Here, the processing unit 5 includes a control unit that controls the piezoelectric element 19 to move the reference mirror 15 along the optical path of the second light L2, thereby changing the focal condition of the optical path of the second light L2. The piezoelectric element 19 and the mechanism that enables the reference mirror 15 to move along the optical path of the second light L2 by means of the piezoelectric element 19 constitute a mechanism configured to change the focal point of the optical path of the second light L2.

The processing unit 5 separates the observation surface information and the non-observation surface information based on a first phase image (first interference image) obtained when the reference mirror 15 is located at a first position and a first phase image (second interference image) obtained when the reference mirror 15 is moved from the first position along the optical path of the second light L2 by a distance equal to or greater than half the wavelength (2/2) of the light output from the light source 2 (details will be described later).

### [Example of Operation of Interference Observation Device]

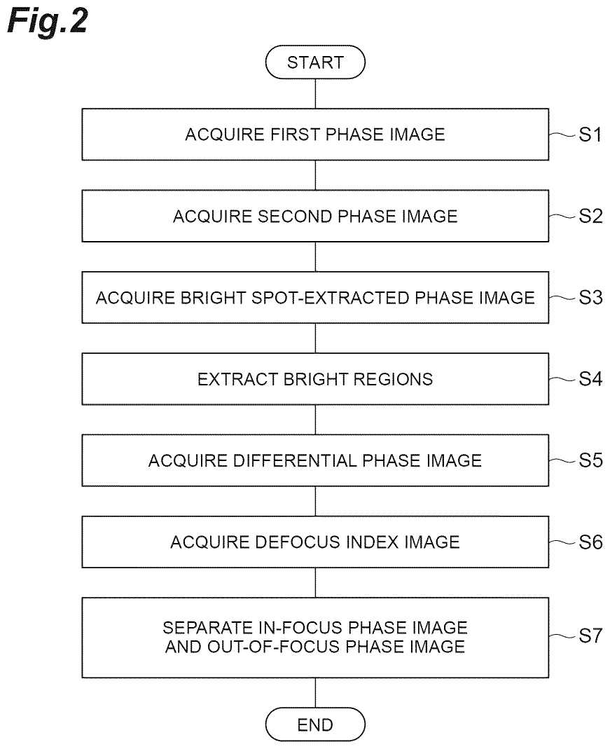

Next, an interference observation method using the interference observation device 1 will be described with reference to FIG. 2. In one example below, the observation surface R inside the observation object 8 is observed (observed through the cap). The interference optical system 3 causes the first light L1 to be incident on the observation object 8 from the first layer 81 side. The observation surface R is the front surface of the third layer 83. The non-observation surface includes the front surface and the back surface of the first layer 81.

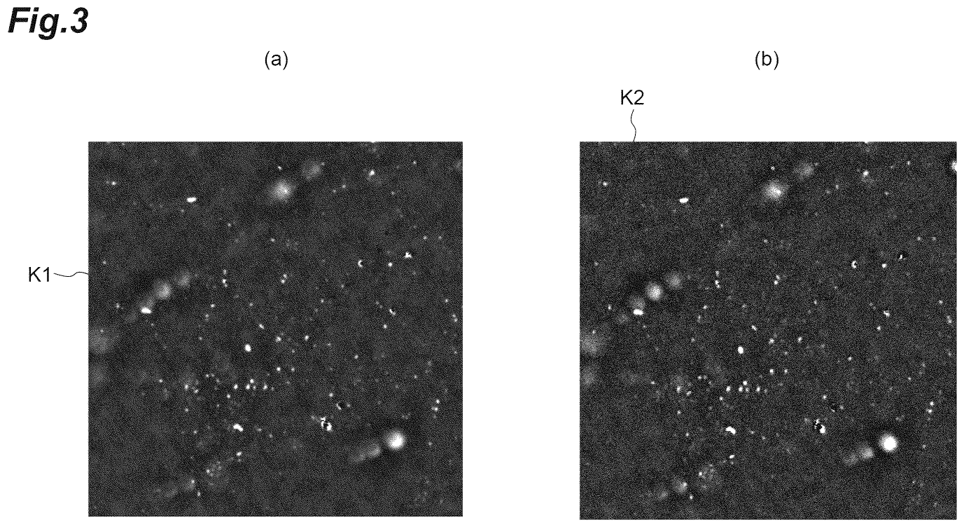

First, the processing unit 5 controls the actuator 16 to move the objective lens 13 along the Z direction and adjust the position of the objective lens 13 with respect to the observation object 8 such that the focal point (focus position) of the objective lens 13 is aligned with the observation surface R. Specifically, the position of the objective lens 13 is adjusted such that the observation surface R and a light-receiving surface of the image sensor 4 are in an optically conjugate relationship through optical image formation by the objective lens 13 and the lens 41. The processing unit 5 controls the piezoelectric element 19 to move the reference mirror 15 to a front position. The front position is, for example, the first position close to the reference objective lens 14. The image sensor 4 captures and acquires four interference images. The processing unit 5 constructs (acquires) one first phase image K1 shown in FIG. 3(a) as a phase image, based on the four acquired interference images (step S1).

When the four acquired interference images are designated as Img 1, Img 2, Img 3, and Img 4 in order, a phase image @ is can be calculated by the following Equation (F1).

Φ=Atan2((Img1−Img3)/(Img4−Img2)) (F1)

In addition, in addition to the calculation equation for calculating a phase image shown here, many types of algorithms for calculating a phase image from one or a plurality of interference images are widely known, and can be applied to the method of the present embodiment. Incidentally, background distortion may remain in the phase image obtained here; however, the background distortion in the phase image can be corrected by polynomial approximation or the like.

In addition, a complex amplitude image E in which pixel values are complex numbers may be calculated as an image that retains information on both a phase component and an amplitude component contained in the four interference images, and then may be used in subsequent processing. The complex amplitude image E can be calculated by the following Equation (F2).

E=(Img4−Img2)+i(Img1−Img3) (F2)

Here, it is a complex unit.

Subsequently, the processing unit 5 controls the piezoelectric element 19 to move the reference mirror 15 from the front position to a rear position, for example, by 4 μm. Accordingly, the focal condition of the optical path of the second light L2 is changed. The rear position is, for example, a second position farther from the reference objective lens 14 than the front position. The image sensor 4 captures and acquires four interference images. The processing unit 5 constructs (acquires) one second phase image K2 shown in FIG. 3(b) as a phase image, based on the four acquired interference images (step S2).

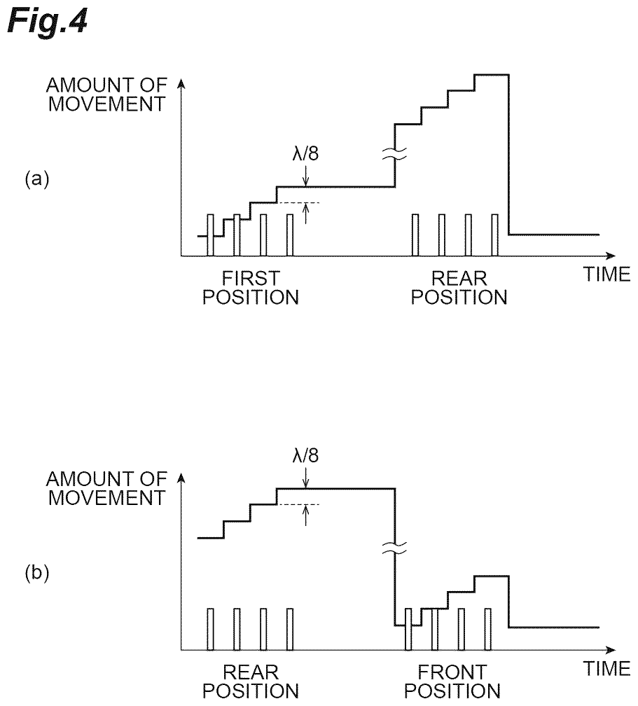

FIGS. 4(a) and 4(b) are timing charts showing a mode of the operation of the reference mirror 15. FIG. 4(a) shows a timing chart for a case in which the reference mirror 15 is located at the front position and four interference images are captured, and then the reference mirror 15 is located at the rear position and four interference images are captured. When the four interference images are captured at each position, the reference mirror 15 finely moves with a step width of λ/8 described above; however, the amount of fine movement is significantly smaller than the amount of movement between the front position and the rear position, for example, 4 μm, and the change in the focal condition on the reference optical path side during the capture of the four consecutive interference images is negligible.

In addition, regarding the temporal order between capturing an interference image in a state in which the reference mirror 15 is located at the front position and capturing an interference image in a state in which the reference mirror 15 is located at the rear position, the former may be performed first or the latter may be performed first. FIG. 4(b) shows a timing chart for a case in which the reference mirror 15 is located at the rear position and interference images are captured, and then the reference mirror 15 is located at the front position and interference images are captured.

As a movement mechanism for the reference mirror 15 for switching the reference mirror 15 between the front position and the rear position, the stepping motor 18 may be used instead of the piezoelectric element 19. Even in this case, for example, the position of the reference mirror 15 can be controlled according to the timing chart shown in FIG. 4(a). However, between the piezoelectric element 19 and the stepping motor 18, the piezoelectric element 19 has a longer lifespan in terms of the number of reciprocations, and therefore, from the standpoint of the lifespan of the device, it is preferable that the piezoelectric element 19 is used to switch the reference mirror 15 between the front position and the rear position.

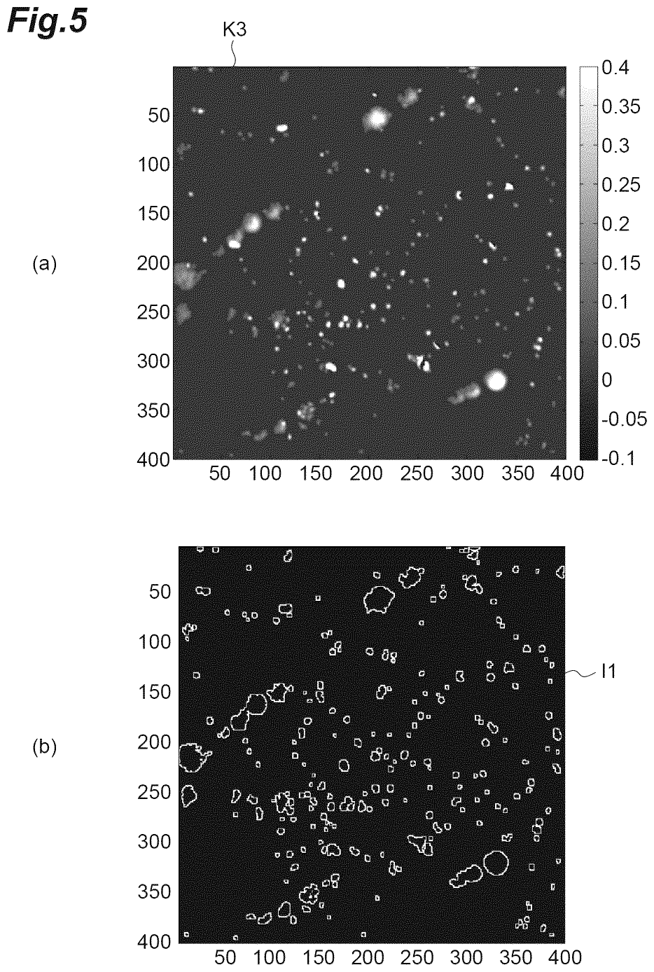

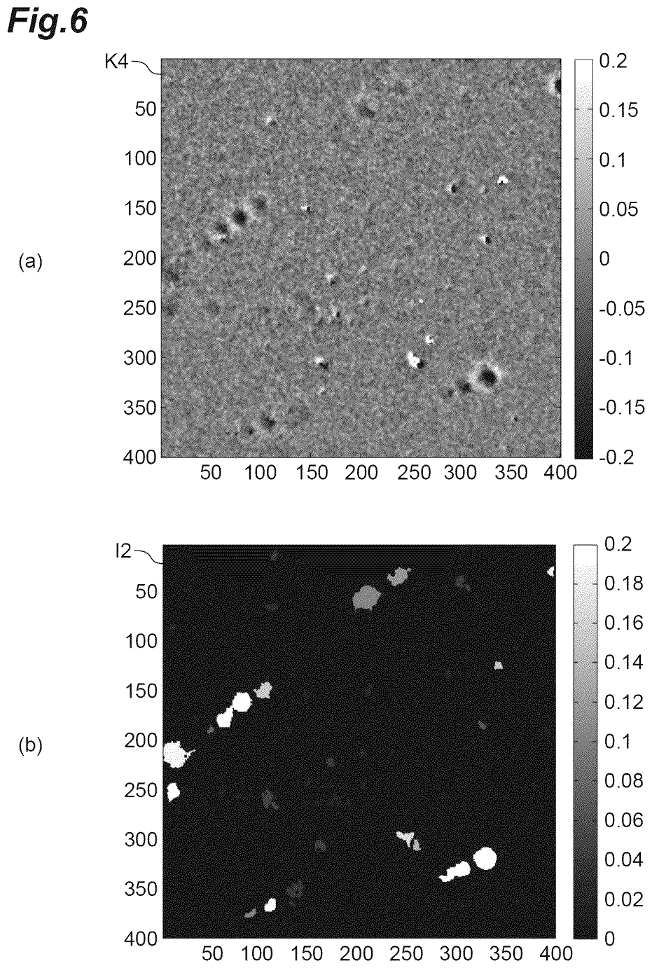

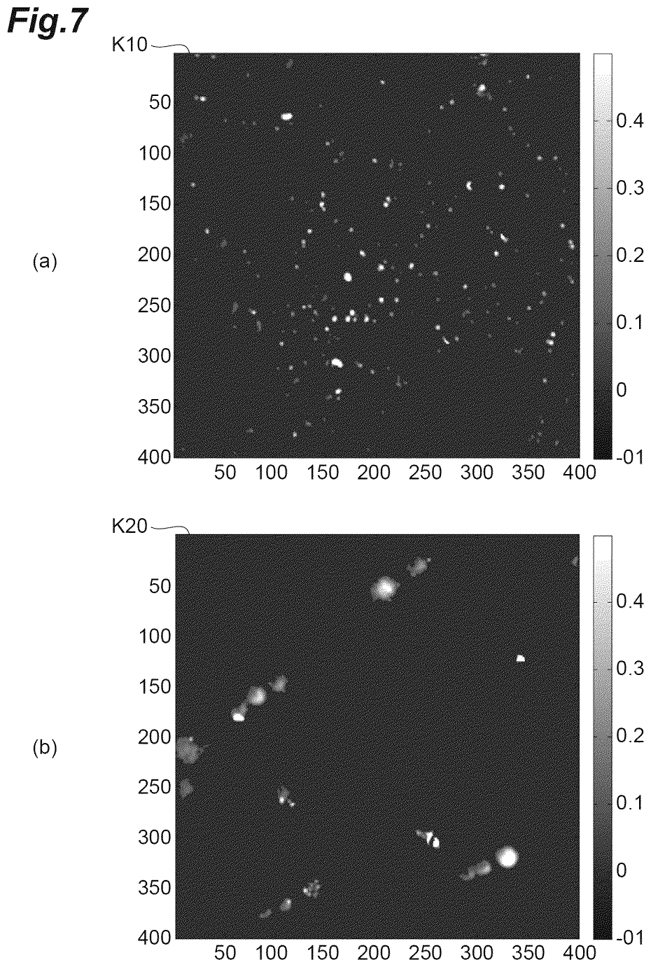

Subsequently, the processing unit 5 acquires a bright spot-extracted phase image K3 shown in FIG. 5(a) from the first phase image K1 and the second phase image K2 (step S3). The bright spot-extracted phase image K3 is a phase image obtained by performing threshold processing, which is a known method, on an average image of the first phase image K1 and the second phase image K2 to extract only bright spots equal to or greater than a threshold value. In FIG. 5(a), the darkness corresponds to luminance, and the horizontal axis and the vertical axis correspond to an X-coordinate position and a Y-coordinate position, respectively (the same applies to FIGS. 6(a) to 7(b)). Incidentally, instead of extracting bright spots using the average image of the first phase image K1 and the second phase image K2, one of the first phase image K1 and the second phase image K2 may be used.

Subsequently, the processing unit 5 extract bright spot regions of the bright spot-extracted phase image K3, and acquires a bright spot position image I1 shown in FIG. 5(b) (step S4). The bright spot position image I1 is an image showing the bright spot regions of the bright spot-extracted phase image K3. The bright spot position image I1 is an image obtained by performing threshold processing on the bright spot-extracted phase image K3 to binarize the bright spot-extracted phase image K3, and then performing a labeling process, which is a known method, to extract the bright spot regions of the bright spot-extracted phase image K3. In FIG. 5(b), the horizontal axis and the vertical axis correspond to an X-coordinate position and a Y-coordinate position, respectively.

Subsequently, the processing unit 5 calculates a difference between the first phase image K1 and the second phase image K2, and acquires a differential phase image K4 shown in FIG. 6(a) (step S5). In step S5, when the differential phase image K4 is denoted as ΔΦ(x, y), the first phase image K1 is denoted as Φ1(x, y), and the second phase image K2 is denoted as Φ2(x, y), the differential phase image K4 is expressed as ΔΦ(x, y)=Abs(Φ2(x, y)−Φ1(x, y)).

Subsequently, the processing unit 5 calculates a distribution of the defocus degrees of the differential phase image K4, and acquires a defocus index image 12 shown in FIG. 6(b) as an image representing the defocus degree (step S6). In step S6, the following processing is performed for each bright spot region shown in the bright spot position image I1. First, an average luminance Qa in the bright spot region of the first phase image K1 is obtained. An average luminance Qb in the bright spot region of the second phase image K2 is obtained. The following Equation (1) is calculated to obtain the defocus degree as an index of the difference. Namely, a coefficient of variation is obtained by dividing the amount of luminance variation by the average value. Such processing is performed for all the bright spot regions in the field of view of the differential phase image K4, and the results are used as the defocus degree of each bright spot region in the differential phase image K4. The defocus degree is an index of the amount of defocus, and corresponds to the degree to which an image is blurred.

Defocus degree=Abs(Qa−Qb)/(0.5×(Qa+Qb)) (1)

Incidentally, when the phase image captured by the image sensor 4 with the reference mirror 15 moved to the front position is denoted as Φ1(x, y), and the phase image captured by the image sensor 4 with the reference mirror 15 moved to the rear position is denoted as Φ2(x, y), the above Equation (1) can be rewritten as the following Equation (2).

Defocus degree=Abs(average value in the bright spot region of Φ(x,y)/average value in the bright spot region of Φave(x,y)) (2)

Here,
ΔΦ(x, y)=Φ2(x, y)−Φ1(x, y),
Φave=0.5×(Φ2(x,y)+Φ1(x, y)

Subsequently, the processing unit 5 refers to the defocus index image 12 based on the bright spot-extracted phase image K3, and separately acquires an in-focus phase image K10 (see FIG. 7(a)) corresponding to components in the bright spot-extracted phase image K3, the defocus degree of which is less than a predetermined value, and an out-of-focus phase image K20 (see FIG. 7(b)) corresponding to components in the bright spot-extracted phase image K3, the defocus degree of which is equal to or greater than the predetermined value (step S7).

The in-focus phase image K10 is observation surface information. The in-focus phase image K10 is information within the focal depth of the first light L1. The in-focus phase image K10 corresponds to an image showing only components related to the observation surface R in the bright spot-extracted phase image K3. For example, the in-focus phase image K10 is an image obtained by extracting the regions in the bright spot-extracted phase image K3, the defocus degree of which is less than the predetermined value, with reference to the defocus index image 12. The out-of-focus phase image K20 is non-observation surface information. The out-of-focus phase image K20 is information outside the focal depth of the first light L1. The out-of-focus phase image K20 corresponds to an image showing only components related to the non-observation surface in the bright spot-extracted phase image K3. For example, the out-of-focus phase image K20 is an image obtained by extracting the regions in the bright spot-extracted phase image K3, the defocus degree of which is equal to or greater than the predetermined value, with reference to the defocus index image 12. The predetermined value is a value set in advance, is not particularly limited, and may be a value that can be changed by an input from a user. The predetermined value is, for example, 0.05.

### [Actions and Effects]

As a result of diligent study, the inventors have found that when the focal condition of the optical path of the second light L2 is changed in a state in which the focal point of the first light L1 is aligned with the observation surface R of the observation object 8, in the plurality of acquired interference images, the amount of modulation received by the components related to the non-observation surface other than the observation surface R is significantly greater than the amount of modulation received by the components related to the observation surface R. Therefore, in the interference observation device 1 and the interference observation method, the in-focus phase image K10 and the out-of-focus phase image K20 are separated based on the plurality of interference images acquired in such a manner. Accordingly, for example, since the in-focus phase image K10 can be selectively obtained by excluding the out-of-focus phase image K20, which reflects cutting marks, dirt, dust, or the like on the non-observation surface, from the bright spot-extracted phase image K3, the in-focus phase image K10 can be acquired with high accuracy. It is possible to remove the non-observation surface information and obtain only the observation surface information without making any changes to the optical system from the observation object 8 to the image sensor 4 (without moving the optical module M or the observation object 8 upward and downward).

The interference observation device 1 and the interference observation method separates the in-focus phase image K10 and the out-of-focus phase image K20 based on the first phase image K1 obtained when the reference mirror 15 is located at the front position and the second phase image K2 obtained when the reference mirror 15 is moved by a distance equal to or greater than half the wavelength (λ/2) to be located at the rear position, and in this case, the in-focus phase image K10 and the out-of-focus phase image K20 can be separated by moving the reference mirror 15 along the optical path of the second light L2.

In the interference observation device 1 and the interference observation method, the observation surface R is the front surface of the third layer 83, and the non-observation surface includes the front surface and the back surface of the first layer 81. In this case, the in-focus phase image K10 related to the front surface of the third layer 83 that is a device portion can be acquired with high accuracy while suppressing the influence of the front surface and the back surface of the first layer 81 that is a cap portion.

### [Other Configurations of Interference Observation Device]

The storage region 51 stores at least one of the acquired images, namely, the first phase image K1, the second phase image K2, the bright spot-extracted phase image K3, the differential phase image K4, the in-focus phase image K10, the out-of-focus phase image K20, the bright spot position image I1, and the defocus index image 12. In this case, foreign objects on the observation surface R and foreign objects on the non-observation surface can be easily distinguished and identified by using each image stored in the storage region 51.

The display unit 53 displays at least one of the acquired images, namely, the first phase image K1, the second phase image K2, the bright spot-extracted phase image K3, the differential phase image K4, the in-focus phase image K10, the out-of-focus phase image K20, the bright spot position image I1, and the defocus index image 12. In this case, foreign objects on the observation surface R and foreign objects on the non-observation surface can be easily distinguished and identified by each image displayed on the display unit 53.

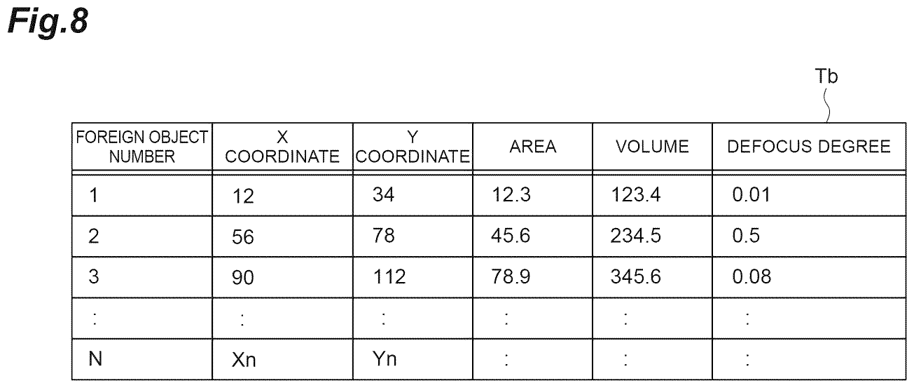

The processing unit 5 generates a defocus index table Tb shown in FIG. 8, based on the bright spot-extracted phase image K3 and the bright spot position image I1. The defocus index table Tb is a table showing the positions of a plurality of foreign objects in the bright spot-extracted phase image K3, and the defocus degree of each of the plurality of foreign objects. The “area” in the defocus index table Tb is the area of a bright spot region corresponding to each foreign object in the bright spot-extracted phase image K3. The “volume” in the defocus index table Tb is a value obtained by integrating the phase values of pixels, which are included in each bright spot region corresponding to each foreign object in the bright spot-extracted phase image K3, over the entire region. For example, the “volume” of a bright spot region including 2×2 pixels and having a phase value of 3 [radians] is 2×2×3=12 [radian·pixel²]. The unit may be converted to [radian·μm²], or may be converted to [μm³] using the proportional relationship between the thickness of the foreign object and the phase value.

The storage region 51 stores the defocus index table Tb. In this case, foreign objects on the observation surface R and foreign objects on the non-observation surface can be easily distinguished and identified by using the defocus index table Tb stored in the storage region 51. The display unit 53 displays the defocus index table Tb. In this case, foreign objects on the observation surface R and foreign objects on the non-observation surface can be easily distinguished and identified by the defocus index table Tb displayed on the display unit 53.

### Second Embodiment

Next, a second embodiment will be described. In the description of the second embodiment, differences from the first embodiment will be described, and duplicate descriptions will be omitted.

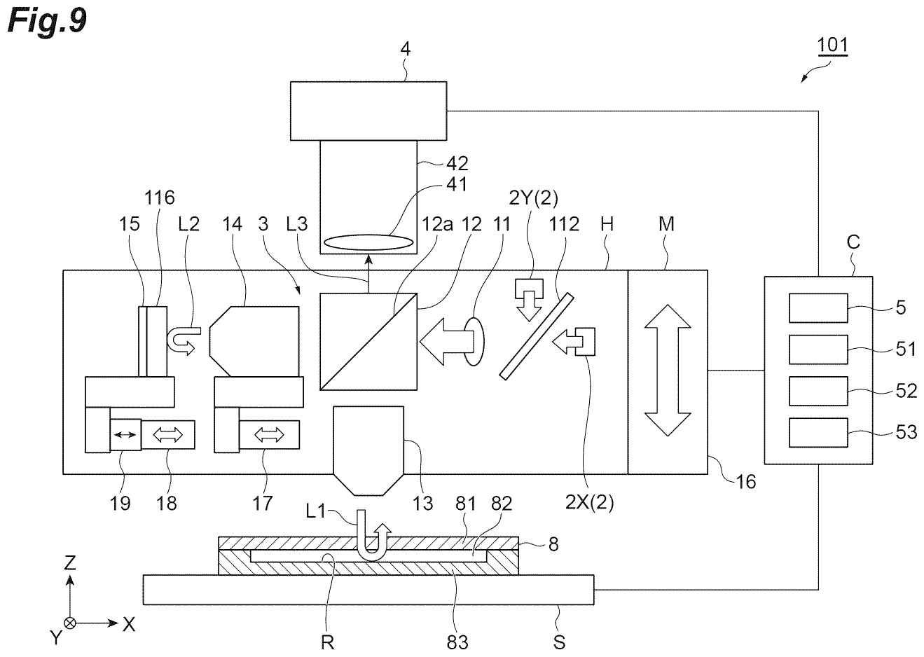

As shown in FIG. 9, an interference observation device 101 according to the second embodiment differs from that of the first embodiment in that, instead of moving the reference mirror 15 to change the focal condition of the optical path of the second light L2, light of two different wavelengths is used. The interference observation device 101 differs from that of the first embodiment in that the light source 2 includes a first light source 2X and a second light source 2Y and the interference observation device 101 further includes a dispersive medium 116 on the optical path of the second light L2.

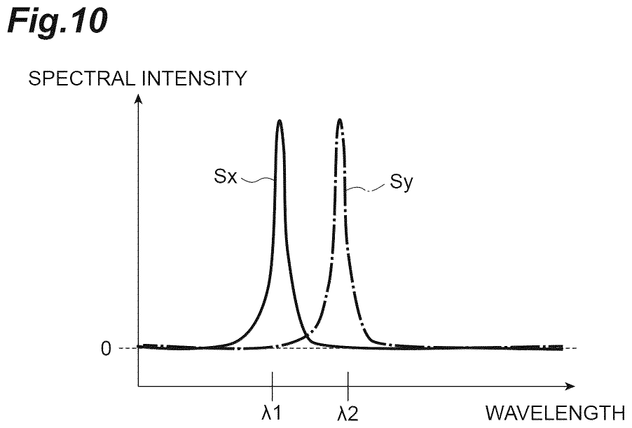

The first light source 2X outputs light of a first wavelength 21. The second light source 2Y outputs light of a second wavelength 22 greater than the first wavelength λ1. As shown in FIG. 10, the light from the first light source 2X has a spectral characteristic Sx in which the spectral intensity peaks at the first wavelength λ1, and the light from the second light source 2Y has a spectral characteristic Sy in which the spectral intensity peaks at the second wavelength λ2. The first light source 2X and the second light source 2Y output substantially monochromatic light. Light is selectively output from one of the first light source 2X and the second light source 2Y, and the light is input to the interference optical system 3 via a dichroic mirror 112.

The dispersive medium 116 is disposed on the optical path of the second light L2 between the beam splitter 12 and the reference mirror 15, specifically, on the optical path of the second light L2 between the reference objective lens 14 and the reference mirror 15. The dispersive medium 116 changes the focus position of the second light L2 depending on the wavelength of the light from one of the first light source 2X and the second light source 2Y.

In the interference observation device 101, in step S1, the first phase image K1 is acquired by outputting light from the first light source 2X and not outputting light from the second light source 2Y. In step S2, the second phase image K2 is acquired by outputting light from the second light source 2Y and not outputting light from the first light source 2X without changing the position of the reference mirror 15 (without moving the reference mirror 15). In such a manner, in the interference observation device 101, simply by switching the light source 2, which outputs light, between the first light source 2X and the second light source 2Y without moving the reference objective lens 14 or the reference mirror 15, the in-focus phase image K10 and the out-of-focus phase image K20 can be separately acquired.

As described above, in the interference observation device 101 as well, the in-focus phase image K10 can be acquired with high accuracy. In addition, the interference observation device 101 can separate the in-focus phase image K10 and the out-of-focus phase image K20 using light of two types of wavelengths. Incidentally, since the relationship between an optical thickness OT of the foreign object and a phase Φ is OT=λΦ/2π, the apparent difference in phase due to the difference in wavelength may be normalized by a factor of the reciprocal of the wavelength. In the present embodiment, the first and second light sources 2X and 2Y and the dispersive medium 116 constitute a mechanism configured to change the focal point of the optical path of the second light L2.

### Third Embodiment

Next, a third embodiment will be described. In the description of the third embodiment, differences from the first embodiment will be described, and duplicate descriptions will be omitted.

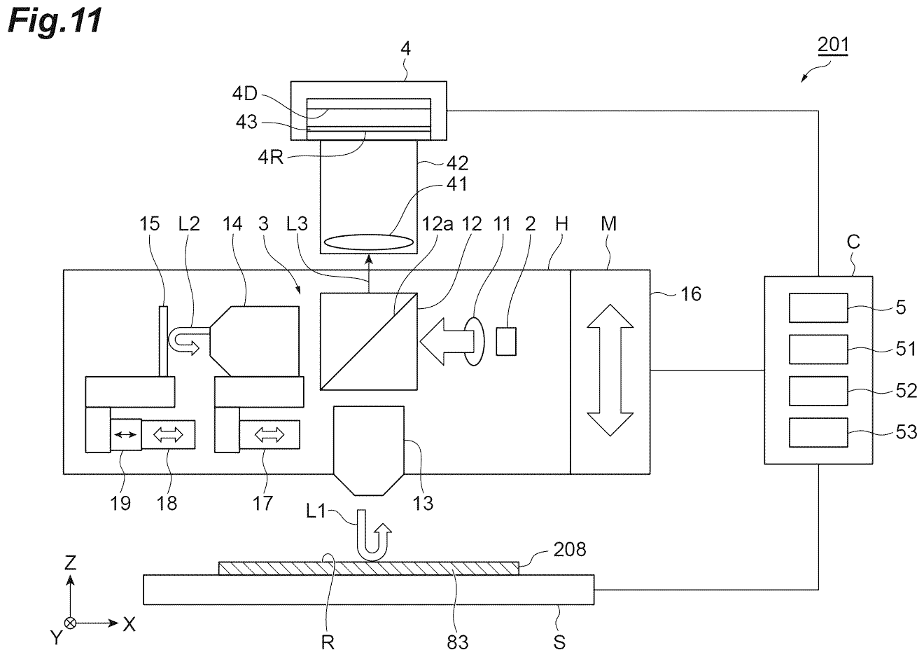

As shown in FIG. 11, an interference observation device 201 according to the third embodiment differs from that of the first embodiment in that, when a single-plate wafer or the like is used as an observation object 208, a front surface (incident surface) of the observation object 208 is defined as the observation surface R, and a front surface 4R (a surface on the observation object 208 side) of a protective plate 43 mounted spaced apart from a detection surface 4D of the image sensor 4 is defined as a non-observation surface, the following processing is performed by the processing unit 5. The protective plate 43 is mounted in front of the detection surface 4D, which detects light, in the image sensor 4 that is normally used in industrial measurement. The protective plate 43 is made of a transparent material. The protective plate 43 is provided to prevent foreign objects (dust, dirt, or the like) from adhering to the detection surface 4D. The distance between the detection surface 4D and the protective plate 43 is designed such that the detection surface 4D and the protective plate 43 are typically spaced apart from each other by approximately 1 mm to 5 mm. In a captured interference image, foreign objects adhering to the front surface 4R of the protective plate 43 appear slightly defocused; however, the foreign objects still hinder quantitative image analysis.

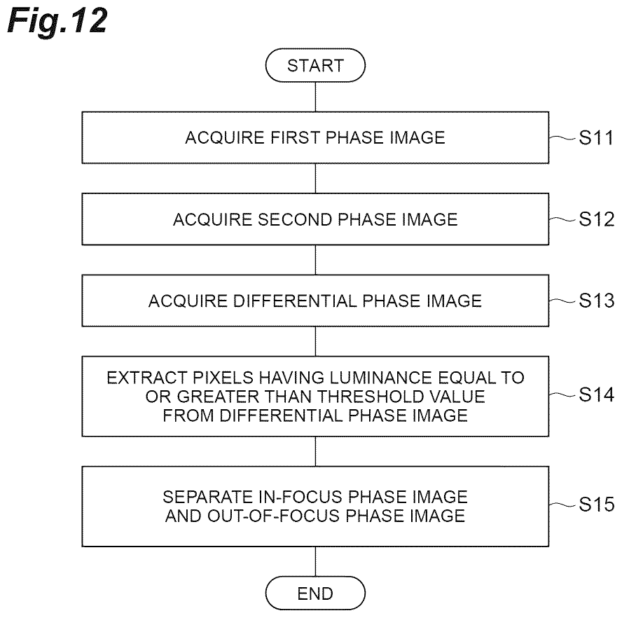

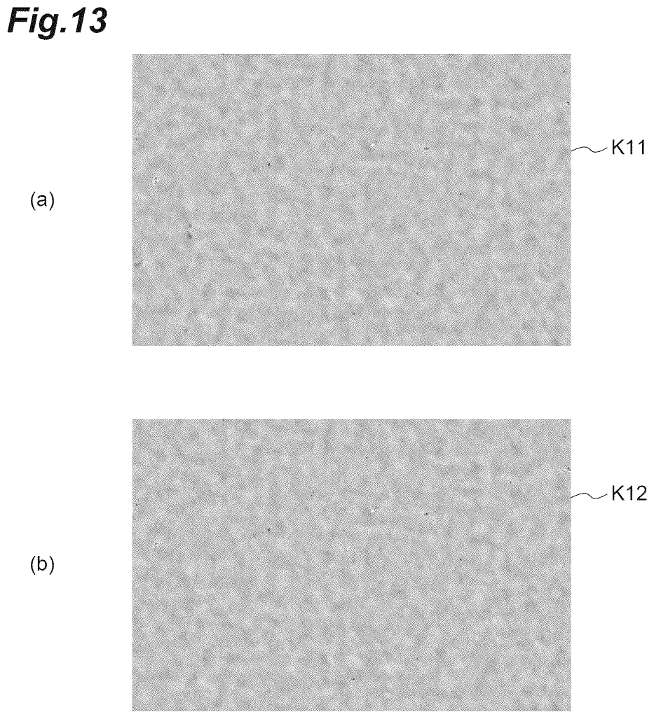

First, as shown in FIG. 12, the processing unit 5 controls the piezoelectric element 19 to move the reference mirror 15 to the front position. The image sensor 4 captures and acquires four interference images. The processing unit 5 constructs (acquires) one first phase image K11 shown in FIG. 13(a), based on the four acquired interference images (step S11).

Subsequently, the processing unit 5 controls the piezoelectric element 19 to move the reference mirror 15 from the front position to the rear position, for example, by 3 μm. Accordingly, the focal condition of the optical path of the second light L2 is changed. The image sensor 4 captures and acquires four interference images. The processing unit 5 constructs (acquires) one second phase image K12 shown in FIG. 13(b), based on the four acquired interference images (step S12).

Subsequently, the processing unit 5 calculates a difference between the first phase image K11 and the second phase image K12, and acquires a differential phase image (step S13). The processing unit 5 extracts pixels having luminance equal to or greater than a threshold value from the differential phase image (step S14). Accordingly, the original differential phase image from which the pixels are extracted is defined as an in-focus phase image, and a differential phase image corresponding to the extracted pixels is defined as an out-of-focus phase image. Namely, the in-focus phase image and the out-of-focus phase image are separately acquired (step S15).

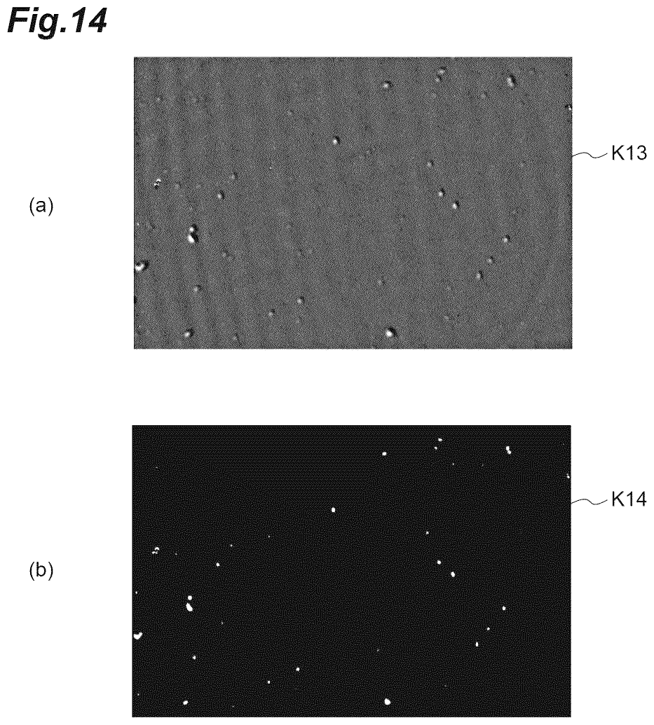

Incidentally, after step S13, the processing unit 5 may acquire a differential phase image K13 shown in FIG. 14(a) by enhancing the contrast of the acquired differential phase image. The processing unit 5 may acquire a differential phase image K14 shown in FIG. 14(b) by performing a binarization process on the differential phase image K13. Accordingly, the differential phase image K14 can be separated as an out-of-focus phase image that clearly shows foreign objects such as dust on the front surface 4R of the protective plate 43.

As described above, in the interference observation device 201 as well, the in-focus phase image can be acquired with high accuracy. In addition, the interference observation device 201 can acquire the in-focus phase image of the observation object 208 with high accuracy while suppressing the influence of the front surface 4R of the protective plate 43 of the image sensor 4.

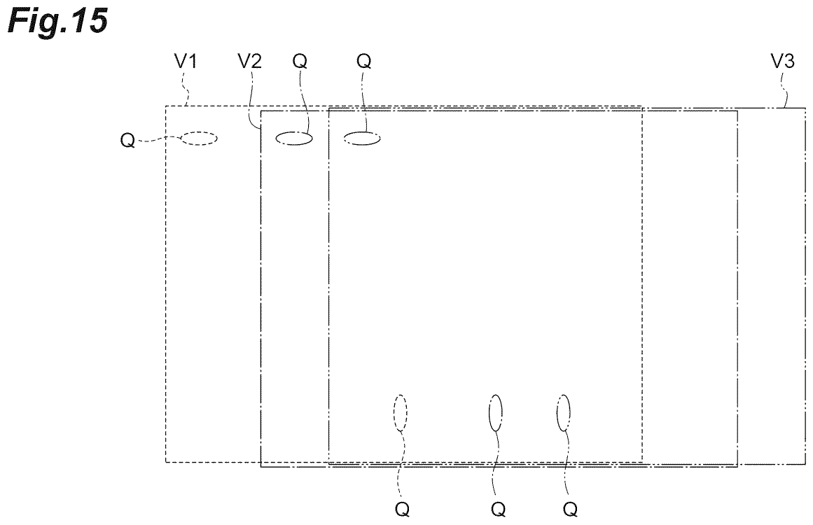

Incidentally, in the present embodiment, the out-of-focus phase image related to foreign objects on the front surface 4R of the protective plate 43 of the image sensor 4 may be used as follows. Namely, a plurality of phase images are acquired by capturing images of the observation object 208 while moving the stage S along the XY plane. Calibration is performed by substracting an out-of-focus phase image from each of the plurality of acquired phase images. Specifically, in the calibration, a foreign object that overlaps a foreign object in the differential phase image K14 (a foreign object on the front surface 4R of the protective plate 43) is not counted as a foreign object. For example, as shown in FIG. 15, for a spot in a phase image of a certain field of view V2 that overlaps a foreign object Q on the front surface 4R of the protective plate 43, a phase image of another field of view V1 or field of view V3 in which the spot does not overlap the foreign object Q on the front surface 4R of the protective plate 43 is adopted.

In addition, similarly to detecting foreign objects on the front surface 4R of the protective plate 43 of the image sensor 4, foreign objects on a front surface (any surface) of an optical element located between the detection surface 4D of the image sensor 4 and the objective lens 13 may be detected. The front surface of the optical element may be a front surface of the beam splitter 12 or a front surface of the lens 41 in the lens barrel 42. In these cases as well, the in-focus phase image and the out-of-focus phase image can be separated using the difference between the phase image acquired at the front position of the reference mirror 15 and the phase image acquired at the rear position of the reference mirror 15 as an index.

### Modification Examples

In the above-described embodiments, the focal condition of the optical path of the second light L2 is changed by moving the reference mirror 15; however, instead of or in addition to this configuration, the focal condition of the optical path of the second light L2 may be changed by moving the reference objective lens 14. In this case, the processing unit 5 may construct the first phase image based on a plurality of interference images acquired by the image sensor 4 in a state in which the processing unit 5 controls the stepping motor 17 to move the reference objective lens 14 to the front position. The processing unit 5 may construct the second phase image based on a plurality of interference images acquired by the image sensor 4 in a state in which the processing unit 5 controls the stepping motor 17 to move the reference objective lens 14 to the rear position. Furthermore, the processing unit 5 may separate the observation surface information and the non-observation surface information based on the first phase image and the second phase image. Incidentally, in this case, the stepping motor 17 and the mechanism that enables the reference objective lens 14 to move along the optical path of the second light L2 by means of the stepping motor 17 constitute a mechanism configured to change the focal point of the optical path of the second light L2.

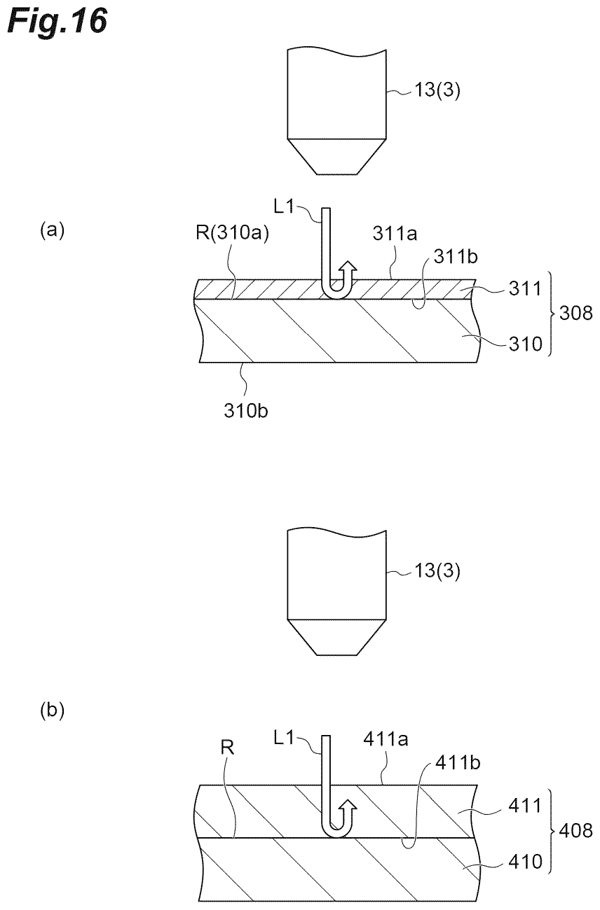

In the above-described embodiments, instead of the observation objects 8 and 208, various objects may be used as the observation object. For example, an observation object 308 shown in FIG. 16(a) may be used as the observation object. The observation object 308 is a so-called film-coated wafer. The observation object 308 includes a device portion 310 constituting a patterned chip, and a film portion 311 provided on a front surface of the device portion 310. The interference optical system 3 causes the first light L1 to be incident on the observation object 308 from the film portion 311 side. The observation surface R is a front surface 310a of the device portion 310, and the non-observation surface includes a front surface 311a and a back surface 311b of the film portion 311.

In this case, an in-focus phase image related to the front surface 310a of the device portion 310 can be acquired with high accuracy while suppressing the influence of the front surface 311a and the back surface 311b of the film portion 311. Incidentally, the observation surface R may be a back surface 310b of the device portion 310.

In addition, for example, an observation object 408 shown in FIG. 16(b) may be used as the observation object. The observation object 408 is a so-called bonded wafer. The observation object 408 includes a first device portion 410 and a second device portion 411 provided on a front surface of the first device portion 410. The interference optical system 3 causes the first light L1 to be incident on the observation object 408 from the second device portion 411 side. The observation surface R is a front surface 410a of the first device portion 410. The non-observation surface includes a front surface 411a and a back surface 411b of the second device portion 411.

In this case, an in-focus phase image related to the front surface 410a of the first device portion 410 can be acquired with high accuracy while suppressing the influence of the front surface 411a and the back surface 411b of the second device portion 411. Incidentally, the observation surface R may be a back surface 410b of the first device portion 410.

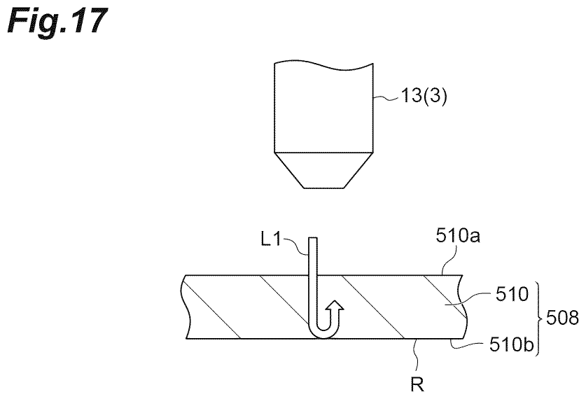

In addition, for example, an observation object 508 shown in FIG. 17 may be used as the observation object. The observation object 508 is a so-called single-plate wafer. The observation object 508 includes a device portion 510 having a plate shape. The interference optical system 3 causes the first light L1 to be incident on the observation object 508 from a front surface 510 side of the device portion 510. The observation surface R is a back surface 510b of the device portion 510, and the non-observation surface is a front surface 510a of the device portion 510. In this case, an in-focus phase image related to the back surface 510b of the device portion 510 can be acquired with high accuracy while suppressing the influence of the front surface 510a of the device portion 510.

In the above-described embodiments, the relative position between the objective lens 13 and the observation object 8 is adjusted by moving the objective lens 13 along the Z direction using the actuator 16; however, instead of or in addition to this configuration, the relative position may be adjusted by moving the stage S along the Z direction. In this case, the stage S is configured to be movable in the Z direction in addition to the X and Y directions. In this case, the actuator 16 may be omitted. The stage S only needs to be movable along a direction intersecting the direction in which the first light L1 is incident on the observation object 8, and for example, may be movable in a direction inclined with respect to the XY plane. The actuators that drive the reference objective lens 14 and the reference mirror 15 are not limited to the stepping motors 17 and 18, and may be other actuators such as a servo motor.

In the above-described embodiments, the interference optical system 3 is configured as a Linnik interference type; however, the interference optical system 3 may be configured as a Michelson interference type or a Mirau interference type. The reference objective lens 14 may be omitted. In the above-described embodiments, the method for acquiring the first phase images K1 and K11 and the second phase images K2 and K12 is not limited to the above-described method, and various known methods may be used. In the above-described embodiments, the number of interference images used to construct the first phase images K1 and K11 and the second phase images K2 and K12 is not particularly limited, and may be one or plural. In the above-described embodiments, the distance between the observation surface R and the non-observation surface is limited; however, it is desirable that, for example, the distance is equal to or greater than the length of the focal depth of the objective lens 13.

In the above-described embodiments, the observation surface information is not limited to the in-focus phase image, and may be other information related to the observation surface. In the above-described embodiments, the non-observation surface information is not limited to the out-of-focus phase image, and may be other information related to the non-observation surface.

Each configuration in the above-described embodiments and the above-described modification examples is not limited to the materials and shapes described above, and various materials and shapes can be applied. In addition, each configuration in the embodiments and the modification examples described above can be arbitrarily applied to each configuration in other embodiments or modification examples.

### REFERENCE SIGNS LIST

1, 101, 201: interference observation device, 2: light source, 2X: first light source (mechanism configured to change focal condition), 2Y: second light source (mechanism configured to change focal condition), 3: interference optical system, 4: image sensor, 4R: front surface of protective plate, 5: processing unit, 8, 208, 308, 408, 508: observation object, 14: reference objective lens, 15: reference mirror, 17: stepping motor (mechanism configured to change focal condition), 18: stepping motor (mechanism configured to change focal condition), 19: piezoelectric element (mechanism configured to change focal condition), 43: protective plate, 51: storage region (storage unit), 53: display unit, 81: first layer (cap portion), 82: second layer (air layer), 83: third layer (device portion), 116: dispersive medium (mechanism configured to change focal condition), 310: device portion, 311: film portion, 410: first device portion, 411: second device portion, 510: device portion, 12: defocus index image, L1: first light, L2: second light, L3: interference light, K1, K11: first phase image (first interference image), K2, K12: second phase image (second interference image), K10: in-focus phase image, K20: out-of-focus phase image, R: observation surface, Tb: defocus index table.

1. An interference observation device, comprising:
a light source that outputs light;
an interference optical system that includes a reference mirror, splits the light output from the light source into a first light and a second light, and outputs interference light between the first light reflected by an observation object and the second light reflected by the reference mirror;
an image sensor that detects the interference light; and
a processing unit that acquires an interference image based on a detection result of the image sensor,
wherein the interference optical system includes a mechanism configured to change a focal condition of an optical path of the second light, and
the processing unit separates observation surface information related to an observation surface of the observation object and non-observation surface information related to a non-observation surface other than the observation surface, based on a plurality of the interference images obtained when the focal condition of the optical path of the second light is changed in a state in which a focal point of the first light is aligned with the observation surface.

2. The interference observation device according to claim 1,
wherein the processing unit separates the observation surface information and the non-observation surface information based on a first interference image obtained when the reference mirror is located at a first position and a second interference image obtained when the reference mirror is moved from the first position along the optical path of the second light by a distance equal to or greater than half a wavelength of the light output from the light source.

3. The interference observation device according to claim 1,
wherein the interference optical system includes a reference objective lens that guides the second light to the reference mirror and that is movable, and
the processing unit separates the observation surface information and the non-observation surface information based on a first interference image obtained when the reference objective lens is located at a first position and a second interference image obtained when the reference objective lens is moved from the first position along the optical path of the second light by a distance equal to or greater than half a wavelength of the light output from the light source.

4. The interference observation device according to claim 1,
wherein the light source includes a first light source that outputs light of a first wavelength, and a second light source that outputs light of a second wavelength different from the first wavelength,
the interference optical system includes a dispersive medium disposed on the optical path of the second light, and
the processing unit separates the observation surface information and the non-observation surface information based on a first interference image obtained when the light is output from the first light source and a second interference image obtained when the light is output from the second light source.

5. The interference observation device according to claim 1,
wherein the observation object includes a device portion and a cap portion provided on a front surface of the device portion via an air layer,
the interference optical system causes the first light to be incident on the observation object from a cap portion side,
the observation surface is the front surface of the device portion, and
the non-observation surface includes a front surface and a back surface of the cap portion.

6. The interference observation device according to claim 1,
wherein the observation object includes a device portion and a film portion provided on a front surface of the device portion,
the interference optical system causes the first light to be incident on the observation object from a film portion side,
the observation surface is the front surface or a back surface of the device portion, and
the non-observation surface includes a front surface and a back surface of the film portion.

7. The interference observation device according to claim 1,
wherein the observation object includes a first device portion and a second device portion provided on a front surface of the first device portion,
the interference optical system causes the first light to be incident on the observation object from a second device portion side,
the observation surface is the front surface or a back surface of the first device portion, and
the non-observation surface includes a front surface and a back surface of the second device portion.

8. The interference observation device according to claim 1,
wherein the observation object includes a device portion,
the interference optical system causes the first light to be incident on the observation object from a front surface side of the device portion,
the observation surface is a back surface of the device portion, and
the non-observation surface is a front surface of the device portion.

9. The interference observation device according to claim 1,
wherein the observation surface is an interface of the observation object, and
the non-observation surface is a front surface of an optical element between a detection surface of the image sensor and the observation object.

10. The interference observation device according to claim 9,
wherein the observation surface is the interface of the observation object, and
the non-observation surface is a front surface of a protective plate of the image sensor, the protective plate being mounted spaced apart from the detection surface of the image sensor.

11. The interference observation device according to claim 1, further comprising:
a display unit that displays at least one of a table showing positions of a plurality of foreign objects in the interference image and a defocus degree of each of the plurality of foreign objects and an image showing a distribution of the defocus degrees in the interference image.

12. The interference observation device according to claim 1, further comprising:
a storage unit that stores at least one of a table showing positions of a plurality of foreign objects in the interference image and a defocus degree of each of the plurality of foreign objects and an image showing a distribution of the defocus degrees in the interference image.

13. An interference observation method, comprising:
a light output step of outputting light from a light source;
an interference light output step of splitting the light output from the light source into a first light and a second light, and outputting interference light between the first light reflected by an observation object and the second light reflected by a reference mirror;
an interference light detection step of detecting the interference light using an image sensor; and
a processing step of acquiring an interference image based on a detection result of the image sensor,
wherein, in the processing step, observation surface information related to an observation surface of the observation object and non-observation surface information related to a non-observation surface other than the observation surface are separated based on a plurality of the interference images obtained when a focal condition of an optical path of the second light is changed in a state in which a focal point of the first light is aligned with the observation surface.
